(19) United States
(12) Patent Application Publication
(10) Pub. No.: US 2019/0215593 A1
(43) Pub. Date: Jul. 11, 2019

(54) Highly-Closed Headphone Apparatus with Wearing Comfort

(71) Applicant: Te-Sheng Liu, New Taipei City (TW)

(72) Inventor: Te-Sheng Liu, New Taipei City (TW)

(21) Appl. No.: 15/867,740

(22) Filed: Jan. 11, 2018

(51) Int. Cl. H04R 1/10

(52) U.S. Cl. CPC H04R 1/1008; H04R 1/105; H04R 1/1058

(57) ABSTRACT

A highly-closed headphone apparatus with wearing comfort mainly includes a headphone main body and a headband pivotally attached onto the headphone main body. The headphone main body includes a housing formed by a front housing member and a rear housing member as well as a speaker arranged inside the housing. The headband includes two ends connected to the housing and a covering pad enclosing an inner surface of the housing thereon. The covering pad is made of a tensile silicon rubber of 30˜50 degrees. The covering pad has a bottom edge portion has a greater thickness and extends upward therefrom to a surface with a decreasing thickness. Accordingly, with the covering pad with the decreasing thickness for positioning, a contact surface thereof is comfortable for wearing to achieve the highly-closed effect without the feeling of compression. Consequently, the headphone apparatus can sufficiently isolate external sounds and provide excellent listening quality.

### TECHNICAL FIELD OF THE INVENTION

The present invention is related to a highly-closed headphone apparatus with wearing comfort, in particular, to a headphone apparatus providing greater wearing comfort and capable of achieving highly-closed effect.

### DESCRIPTION OF THE PRIOR ART

A conventional over-the-ear headphone typically includes speakers built in a housing, a covering pad encloses an inner edge of the housing and a headband is connected to the housing for wearing onto the ears for listening to music or other sounds. Since the covering pads of such known headphone are mostly made of leather or imitation leather, they are of the following drawbacks:

1. The contact pressure of the covering pads are high, and the surface is not smooth enough such that the internal air under its natural state is likely to leak out, affecting the sound quality of listening.

2. Poor closeness between the covering pad and the user's cheek or ear, which tends to cause discomfort and the feel of compression.

3. Poor closeness between the covering pad and the user's cheek or ear such that the external sounds are likely penetrate through the pad, affecting the listening quality.

4. Since the covering pad is made of leather or imitation leather, it is likely to cause cracks and damages after a certain period of time of use, affecting the useful lifetime of the headphone.

In view of the aforementioned drawbacks associated with known arts, after years of researches and experiments, the inventor seeks to provide a highly-closed headphone with wearing comfort in order to provide a headphone with greater wearing comfort and capable of achieving the high-closed effect.

### SUMMARY OF THE INVENTION

A primary objective of the present invention is to provide a highly-closed headphone apparatus with wearing comfort, capable of providing soft and comfortable wearing of the headphone without any feeling of compression, which is also capable of achieving the highly-closed effect to sufficiently isolate external sounds in order to provide excellent sound listening quality.

The aforementioned highly-closed headphone apparatus with wearing comfort comprises a headphone main body and a headband pivotally attached onto the headphone main body, the headphone main body comprising a housing formed by a front housing member and a rear housing member as well as a speaker arranged inside the housing, the headband comprising two ends connected to the housing, and a covering pad enclosing an inner surface of the housing thereon. In addition, the covering pad is configured to have a bottom edge portion with a relatively greater thickness and extends upward from the bottom edge portion to a surface thereof with a gradually decreasing thickness; thereby, with the covering pad having the gradually decreasing thickness for positioning, a contact surface of the headphone apparatus is soft and comfortable during the wearing thereof by a user. Due to the special characteristics of silicon material, it can be fitted with the ear and facial shapes of users more properly than the covering pad made of artificial leather, such that the covering pad of the present invention can be fitted onto cheeks, skeleton and shapes of different races, including adults, children, Asians and Caucasians etc. Consequently, the cheeks and ears of the user of the headphone apparatus of the present invention can be closely fitted without any feeling of compression in order to achieve a highly-closed effect, to sufficiently isolate external sounds and to provide excellent listening quality. Furthermore, the headphone apparatus of the present invention is able to achieve the waterproof effect and reduction of vibration while providing high-frequency compensation. Moreover, the headphone apparatus of the present invention can be further attached with fluffy ear covers externally in order to achieve the warning effect for ears without affecting the listening of sound of the apparatus.

According to the aforementioned highly-closed headphone apparatus with wearing comfort, wherein he covering pad is made of a silicon material, which is a tensile silicon rubber of 30˜50 degrees.

### BRIEF DESCRIPTION OF THE DRAWINGS

FIG. 1 is a perspective exploded view of the present invention;

FIG. 2 is a perspective view of the present invention;

FIG. 3 is a cross sectional view of the present invention; and

FIG. 4 is an illustration showing a state of the covering pad of the present invention under compression.

### DETAILED DESCRIPTION OF THE PREFERRED EMBODIMENTS

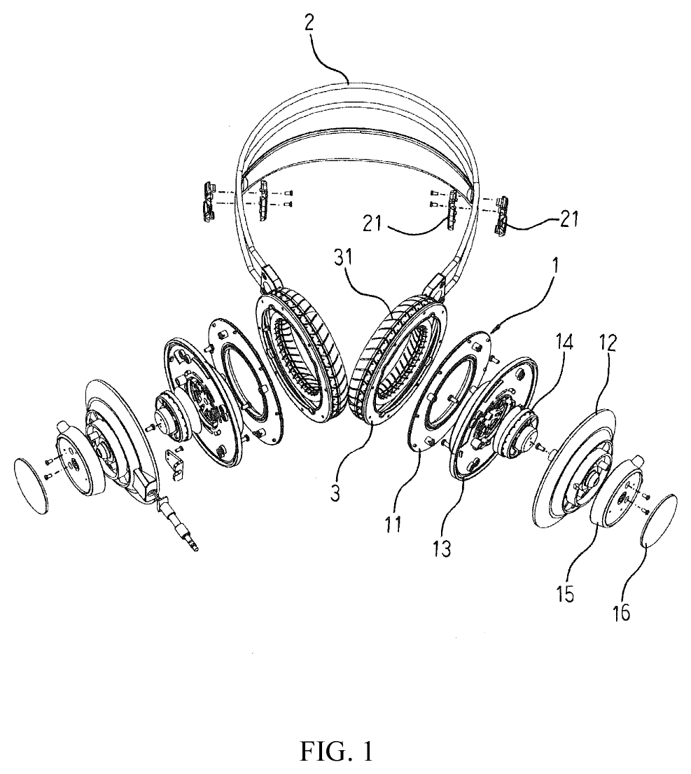

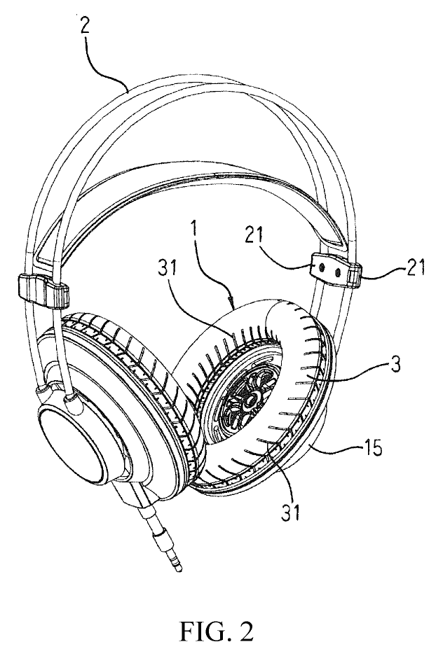

Please refer to FIG. 1 and FIG. 2, showing a perspective exploded view and a perspective view of the present invention. The headphone apparatus of the present invention comprises a headphone main body 1 and a headband 2 pivotally attached onto the headphone main body 1 as well as a covering pad 3 arranged at an inner edge of the headphone main body 1. In addition, the headphone main body 1 comprises a housing formed by a front housing member 11 and a rear housing member 12, and a securement plate 13 is arranged inside the housing and provided for securing onto the front housing member 11 in order to allow a speaker 14 to be secured onto the securement plate 13. The rear housing member 12 includes a headband securement cover 15 and a decorative shield 16.

The two sides of the headband 2 include a headband securement housing 21 arranged thereon respectively, and the two end portions of the headband 2 are pivotally attached onto the headband securement cover 15.

The covering pad 3 encloses the inner surface of the housing of the headphone main body 1, and its bottom edge portion is configured to have a relatively greater thickness and extends upward from the bottom edge portion to the surface thereof with a gradually decreasing thickness. The surface includes a plurality of indented patterns formed thereon and arranged spaced apart from each other in order to increase the supporting force of the covering pad 3. The central concave portion of the covering pad 3 includes a ring-shaped guard plate 32 arranged thereon and used for high-frequency compensation. In this embodiment, the covering pad 3 is made of a silicon material, which is a tensile silicon rubber of 30˜60 degrees.

With the assembly of the aforementioned components, a highly-closed headphone apparatus with wearing comfort of the present invention can be achieved. During the use of the headphone apparatus, a user can wear the headband onto the head and place the headphone main body 1 to attach onto the ear in order to listen to music or other sounds. In addition, since the covering pad 3 is configured to have a gradually decreasing thickness for positioning, a contact surface of the headphone apparatus is soft and comfortable during the wearing thereof by a user such that cheeks and ears of the user can be closely fitted without any feeling of compression in order to achieve a highly-closed effect, to sufficiently isolate external sounds and to provide excellent listening quality. Furthermore, the headphone apparatus of the present invention is able to achieve the waterproof effect and reduction of vibration while providing high-frequency compensation. Moreover, the headphone apparatus of the present invention can be further attached with fluffy ear covers externally in order to achieve the warning effect for ears without affecting the listening of sound of the apparatus.

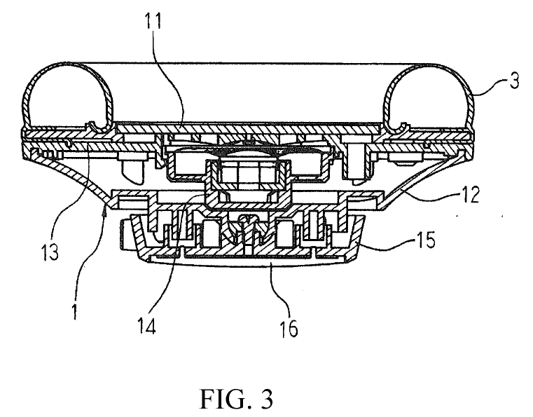

Please refer to FIG. 3, showing a cross sectional view of the present invention. As shown in the drawing, the covering pad 3 of the present invention encloses the inner edge of the housing of the headphone main body 1, and its bottom edge portion is configured to have a relatively greater thickness and extends upward from the bottom edge portion toward the surface with a gradually decreasing thickness. Accordingly, a structure having a bottom edge portion with a greater thickness and a surface with a thinner thickness is formed.

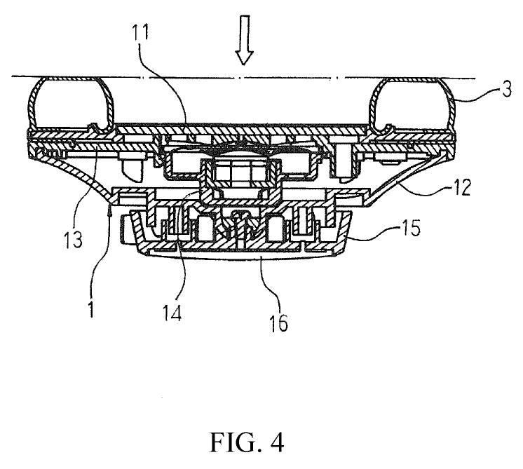

Please refer to FIG. 4, showing a state of the covering pad of the present invention under compression. As shown in the drawing, the covering pad 3 of the present invention is configured to have a greater thickness at the bottom edge portion and to extend upward from the bottom edge portion to the surface having a gradually decreasing thickness. Therefore, when the headphone apparatus is worn by a user, and the covering pad 3 is compressed, the contact area thereof with the ear then becomes greater such that the air-tightness is increased. In addition, since the covering pad 3 is made of a silicon material, it only generates limited deformation during the compression; consequently, the practical application value of the headphone apparatus can be increased.

In comparison to a known headphone, the headphone apparatus of the present invention has at least the following advantages:

1. The design of gradually decreasing thickness for positioning of the covering pad is able to provide a soft and comfortable contact surface. The contact surface can be enlarged in order to achieve the highly-closed effect such that the external sound is completely isolated from the headphone apparatus.

2. The smooth contact surface can be gently pressed in order to prevent leakage of the internal air under its natural state. When the pressing force is removed, air can be supplemented to the internal.

3. Under the working state of the covering pad, the internal sealing member is able to withstand pressure in order to allow limited deformation only without affecting the quality of the sound.

4. The covering pad 3 can be fitted closely with the user's cheeks and ears in order to allow the wearing of the headphone apparatus to be more comfortable without any feeling of compression.

5. It can be removed for cleaning such that it complies with the environmental health requirements.

6. The material is resistant to abrasion and is durable such that the useful lifetime of the headphone apparatus is increased.

7. Due to the special characteristics of silicon material, it can be fitted with the ear and facial shapes of users more properly than the covering pad made of artificial leather, such that the covering pad of the present invention can be fitted onto cheeks, skeleton and shapes of different races, including adults, children, Asians and Caucasians etc.

8. It is of the water repellent function and can be removed for cleaning, which is unlike the artificial material having the drawbacks of exposure with peeled skins and contamination due to water or polluted water.

9. It has increased air chamber and space such that the frequency response performance is better.

10. It is able to achieve the effects of vibration and noise reductions.

11. The facial protective shield design is able to provide the high-frequency compensation effect in order to enhance the sound quality.

I claim:

1. A highly-closed headphone apparatus with wearing comfort, comprising a headphone main body and a headband pivotally attached onto the headphone main body, the headphone main body comprising a housing formed by a front housing member and a rear housing member as well as a speaker arranged inside the housing, the headband comprising two ends connected to the housing, and a covering pad enclosing an inner surface of the housing thereon, characterized in that:
the covering pad is configured to have a bottom edge portion with a relatively greater thickness and extends upward from the bottom edge portion to a surface thereof with a gradually decreasing thickness; thereby, with the covering pad having the gradually decreasing thickness for positioning, a contact surface of the headphone apparatus is soft and comfortable during the wearing thereof by a user such that cheeks and ears of the user can be closely fitted without any feeling of compression in order to achieve a highly-closed effect, to sufficiently isolate external sounds and to provide excellent listening quality.

2. The highly-closed headphone apparatus with wearing comfort according to claim 1, wherein the covering pad is made of a silicon material.

3. The highly-closed headphone apparatus with wearing comfort according to claim 2, wherein the silicon material of the covering pad is a tensile silicon rubber of 30˜50 degrees.

4. The highly-closed headphone apparatus with wearing comfort according to claim 1, wherein the surface of the covering pad includes a plurality of indented patterns formed thereon and spaced apart from each other in order to increase a supporting force of the covering pad.

5. The highly-closed headphone apparatus with wearing comfort according to claim 1, wherein the covering pad includes a central concave portion having a ring-shaped guard plate arranged thereon and provided for high-frequency compensation.
